(19) United States
(12) Patent Application Publication
(10) Pub. No.: US 2019/0045701 A1
(43) Pub. Date: Feb. 14, 2019

(54) GREENS ROLLER

(71) Applicant: GRADEN INDUSTRIES PTY LTD, Thomastown, Victoria (AU)

(72) Inventor: Graham DRYDEN, Thomastown, Victoria (AU)

(21) Appl. No.: 16/077,154

(22) PCT Filed: Feb. 10, 2017
(86) PCT No.: PCT/AU2017/050108

§ 371 Date: Aug. 10, 2018

(30) Foreign Application Priority Data
Feb. 10, 2016 (AU) 2016900436

(51) Int. Cl. A01B 63/00; A01B 63/02; A01B 29/02; A01B 45/00; A01B 73/00

(52) U.S. Cl. CPC A01B 63/002; A01B 63/02; A01B 73/00; A01B 45/00; A01B 29/02

(57) ABSTRACT

A greens roller having a transportation configuration and a rolling configuration, the greens roller comprising: a chassis having powered wheels, the wheels defining a driving direction; one or more rollers rotatably mounted to the chassis, the one or more rollers defining a rolling direction that is different to the driving direction; wherein in the transportation configuration the wheels are lowered to support the chassis for driving the greens roller, and in a rolling configuration the wheels are raised so that the one or more rollers support the chassis for rolling the greens roller on a green.

### FIELD OF THE INVENTION

The invention relates to a greens roller for rolling greens, such as golf and lawn bowls greens.

### BACKGROUND OF THE INVENTION

Keeping greens, such as golf greens, in optimal condition requires regular maintenance including rolling. Mechanical ride on rollers having elongated roller members are effective in efficiently and evenly rolling greens. Transporting some rollers to and from and between greens requires a transportation vehicle having a trailer that the roller is driven up on to. Sometimes, if the surface is flat, rollers can be driven a short distance on the roller members, however roller members are not suitable to drive with over uneven terrain. A disadvantage of such greens rollers is that they require a heavily underutilised transportation vehicle.

It is known to provide greens rollers with their own set of wheels but these too are faced with problems including coordinating separate drive systems for the rollers and wheels.

It is in light of these disadvantages that the current invention has been developed.

### SUMMARY OF THE INVENTION

The invention provides a greens roller having a transportation configuration and a rolling configuration, the greens roller comprising: a chassis having powered wheels, the wheels defining a driving direction; one or more rollers rotatably mounted to the chassis, the one or more rollers defining a rolling direction that is different to the driving direction; wherein in the transportation configuration the wheels are lowered to support the chassis for driving the greens roller, and in a rolling configuration the wheels are raised so that the one or more rollers support the chassis for rolling the greens roller on a green.

It will be understood that the term “greens roller” refers to, for example, rollers for golf greens, lawn bowls greens, grass tennis courts and golf fairways.

By providing a greens roller that has wheels to allow the greens roller to be driven, and rollers to allow the greens roller to roll greens, the need for a transportation vehicle is removed. It also allows the user to quickly drive to the next green, as there is no need to load and unload the greens roller to a transportation vehicle.

In addition, by providing a greens roller in which the rolling direction is different to the driving direction not only is the transportation drive and/or the rolling drive more comfortable for the rider, but the width of the wheels is not determined by the width of the rollers, thereby allowing the wheelbase of the greens roller to be narrower. This allows easier transportation between greens (which are often accessed by narrow paths) while maintaining a large rolling width (and hence fewer passes of the green to roll the entire green).

The driving direction may be substantially perpendicular to the rolling direction. This allows the user to drive the greens roller between greens facing a forward direction relative to the driver's seat, and to operate the greens roller when rolling the greens in a side-to-side motion, which is the preferred rolling position for optimum efficiency and control. The different driving and rolling directions also provide a more ergonomic device.

The invention also provides a greens roller having a transportation configuration and a rolling configuration, the greens roller comprising: a chassis having wheels; one or more rollers rotatably mounted to the chassis; a power source mounted to the chassis; a first actuator for driving the wheels; a second actuator for driving the rollers; and a coupling mechanism to selectively connect either the first actuator or the second actuator to the power source; wherein in the transportation configuration the wheels are lowered to support the chassis and the coupling mechanism connects the first actuator to the power source, and in a rolling configuration the wheels are raised so that the one or more rollers support the chassis and the coupling mechanism connects the second actuator to the power source.

By utilising a single power source, which is selectively connected via a coupling mechanism, the cost of the greens roller can be reduced.

The coupling mechanism can be automatically activated when the wheels transition between a raised position and a lowered position. This reduces the complexity of the greens roller, making it easier and more efficient to use.

### BRIEF DESCRIPTION OF THE DRAWINGS

An embodiment, incorporating all aspects of the invention, will now be described by way of example only with reference to the accompanying drawings in which;

FIG. 1A is an isometric view of a greens roller in accordance with the invention in a transportation configuration;

FIG. 1B is an isometric view of the greens roller shown in FIG. 1A in a rolling configuration;

FIG. 1C is a top view of the greens roller shown in FIG. 1A in the transportation configuration;

FIG. 1D is a front view of the greens roller shown in FIG. 1A in the transportation configuration;

FIG. 2A is a side view of the greens roller shown in FIG. 1A in the transportation configuration;

FIG. 2B is a side view of the greens roller shown in FIG. 1B in the rolling configuration;

FIG. 2C is a close up side view of the linkage shown in FIG. 2A in the transportation configuration;

FIG. 2D is a close up side view of the linkage shown in FIG. 2B in the rolling configuration;

FIG. 3 is a schematic of a hydraulic transmission;

FIG. 4A is an isometric view of the linkage shown in FIG. 2D in the rolling configuration;

FIG. 4B is a close up isometric view of the greens roller shown in FIG. 4A in a rolling configuration;

FIG. 5A is an exploded isometric view of the linkage shown in FIG. 2D in the rolling configuration; and

FIG. 5B is an exploded close up isometric view of the greens roller shown in FIG. 5A in a rolling configuration.

### DETAILED DESCRIPTION OF AN EMBODIMENT OF THE INVENTION

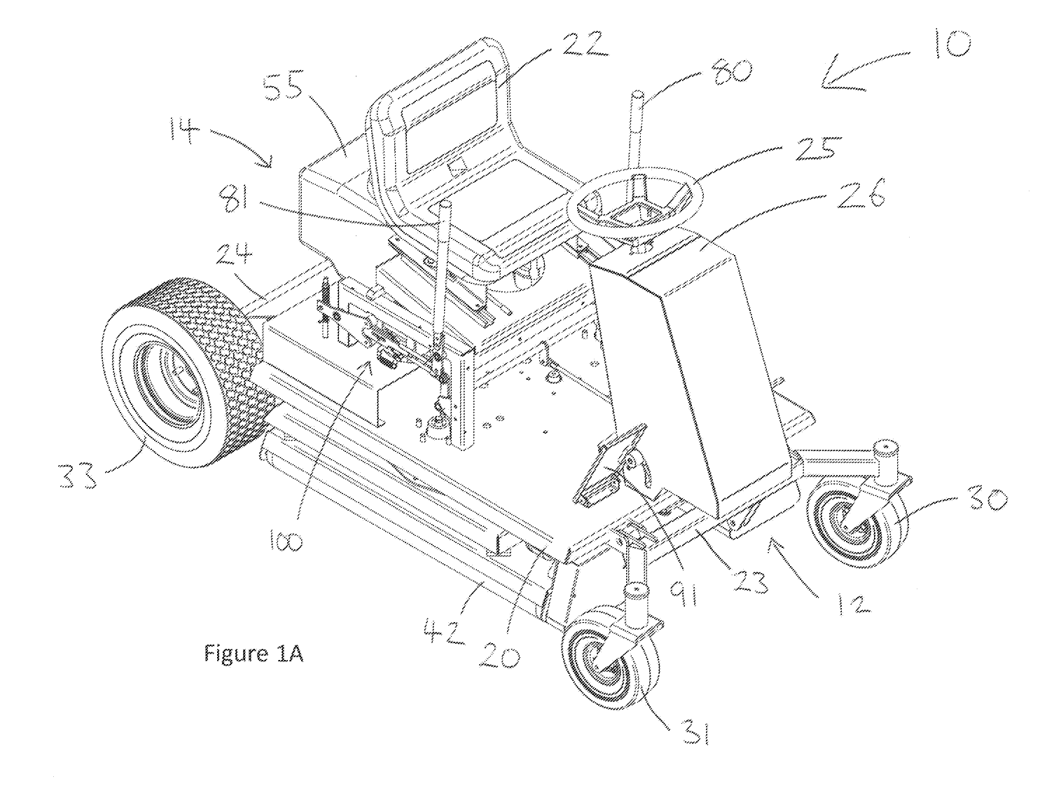

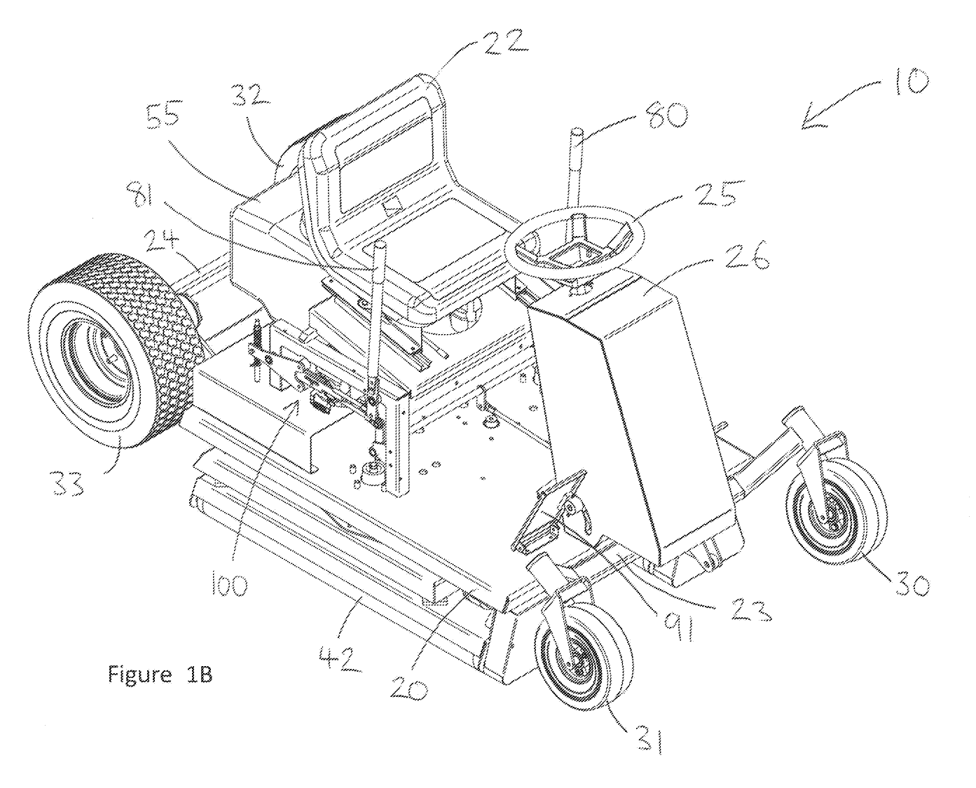

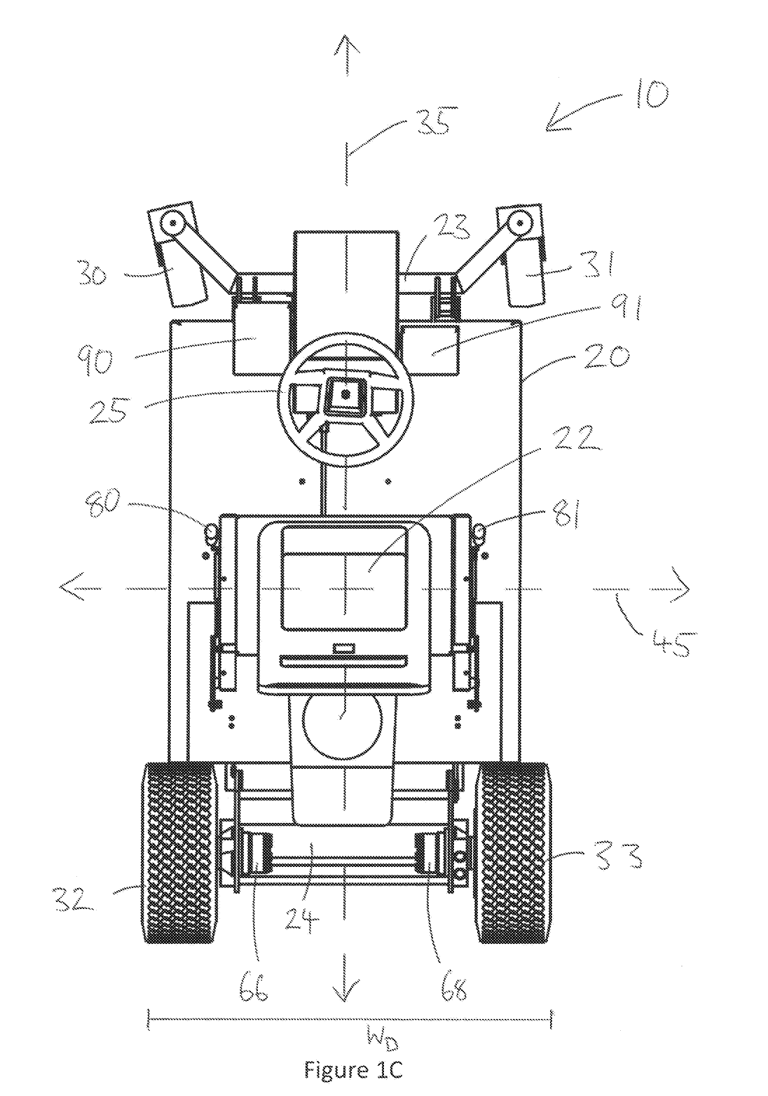

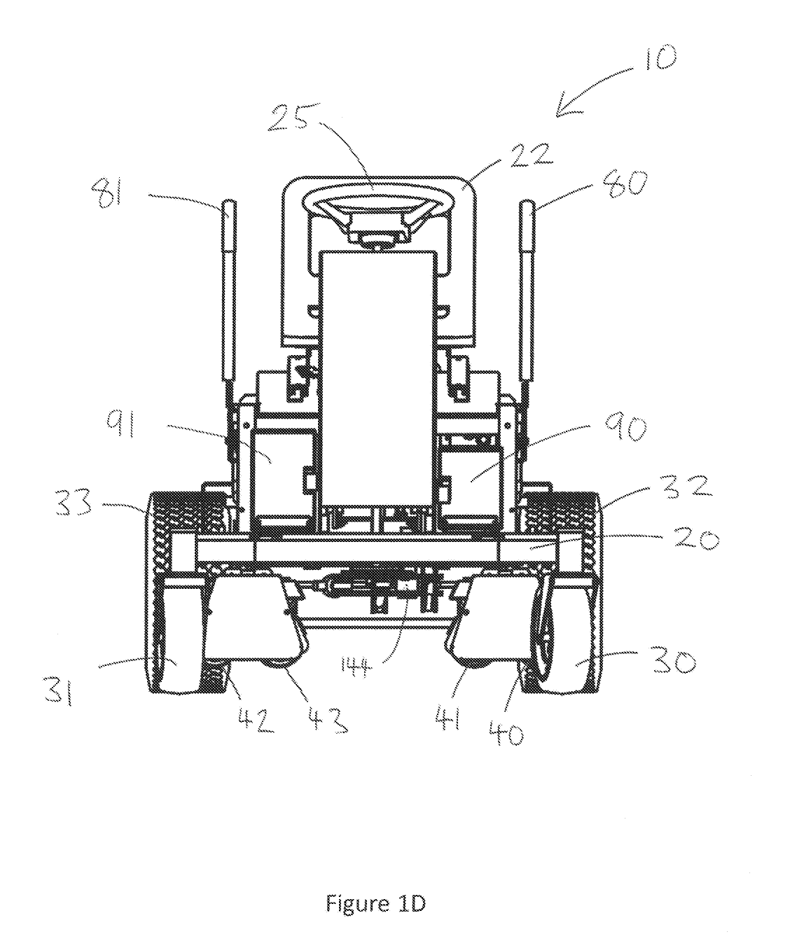

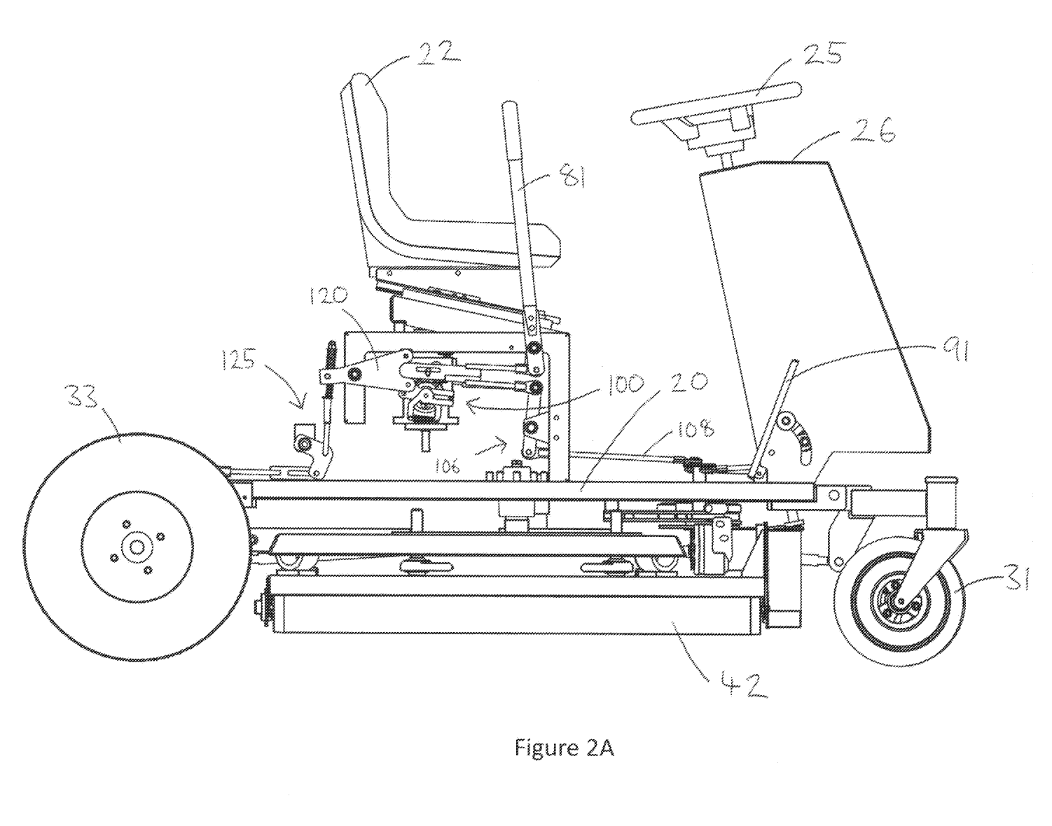

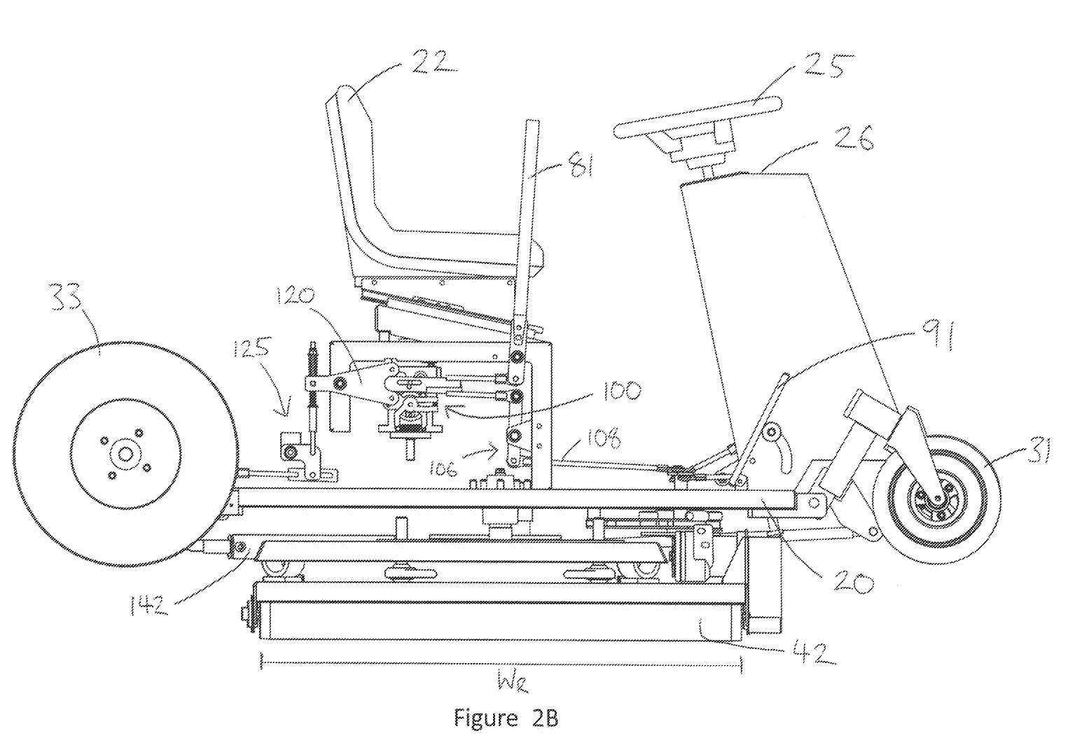

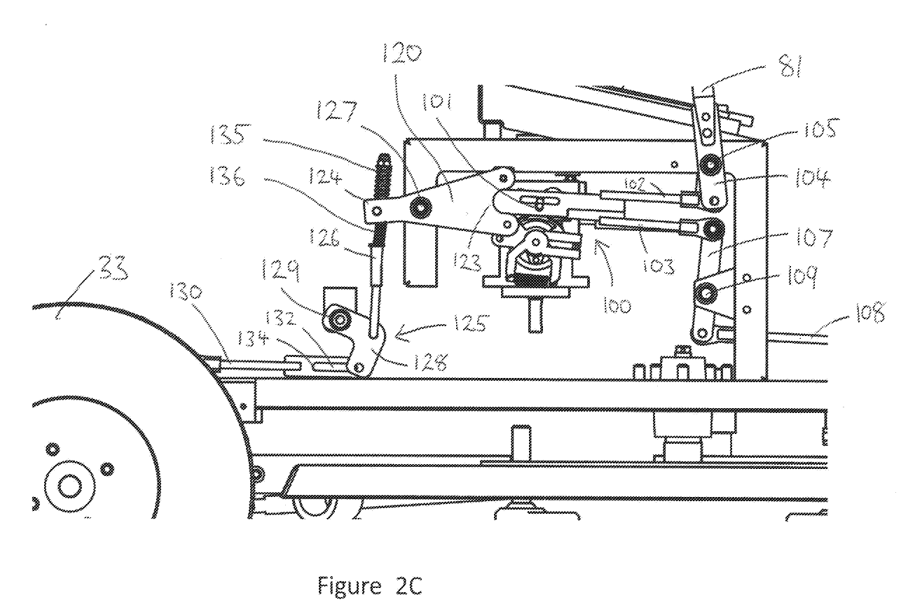

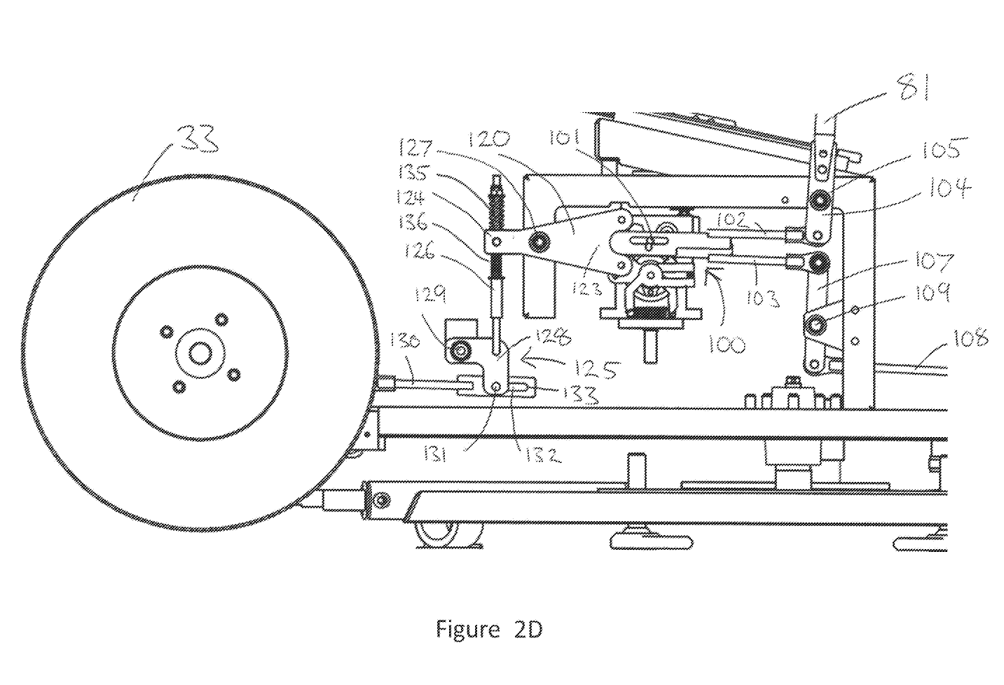

FIGS. 1A to 5B illustrate a greens roller 10 having a transportation configuration (FIGS. 1A and 2A) and a rolling configuration (FIGS. 1B and 2B). The greens roller 10 has a chassis 20 having powered wheels, shown as rear wheels 32, 33. The greens roller also has front wheels 30, 31, with all of the wheels 30, 31, 32, 33 having rubber tyres. The wheels 30, 31, 32, 33 define a driving direction 35. Namely, this is the direction that the greens roller 10 will move in opposite directions when driven straight on the wheels 30, 31, 32, 33, shown in FIG. 1C. In this embodiment that direction is nominated as a forward and rearward direction of the greens roller vehicle.

There are one or more rollers rotatably mounted to the chassis 20, shown as left rollers 40, 41 and right rollers 42, 43. The rollers 40, 41, 42, 43 define a rolling direction 45. Namely, this is the direction that the greens roller 10 will move in opposite directions when driven straight on the rollers 40, 41, 42, 43, shown in FIG. 1C. In this embodiment that direction is nominated as a side-to-side, or left to right, direction.

The rolling direction 45 is different to the driving direction 35. In the transportation configuration the wheels 30, 31, 32, 33 are lowered to support the chassis 20 for driving the greens roller 10, for example between greens. In the rolling configuration the wheels 30, 31, 32, 33 are raised so that the rollers 40, 41, 42, 43 support the chassis 20 for rolling the greens roller 10 on a green. In the embodiment shown the driving direction 35 is angled relative to the rolling direction 45, and more specifically the driving direction 35 is substantially perpendicular, or normal, to the rolling direction 45.

The greens roller 10 has a seat 22 mounted to the chassis 20 for a user (driver/operator) to sit on while operating the greens roller 10. The seat 22 is substantially aligned with the driving direction 35 so that the user faces towards the driving direction 35 when seated in the seat 22. When the user is operating the greens roller 10 in the transportation configuration the user is substantially parallel with the driving direction 35. This allows the user to easily drive the greens roller 10 between greens as the user is facing the driving direction, the same seating position as driving a car. When the user is operating the greens roller 10 in the rolling configuration the user is substantially perpendicular with the rolling direction 45. This allows the user to operate the greens roller 10 in a side-to-side motion, which allows more accurate and efficient rolling as the user can perform a second pass of a green without having to turn around the greens roller. The different driving and rolling directions also provide a more ergonomic device.

The width W_{D} of the wheels 30, 31, 32, 33 (i.e. the distance between the outer edge of the left and right rear wheels 32, 33, see FIG. 1C) is less that the width W_{R} of the rollers 40, 41, 42, 43 (i.e. the width of the green that the greens roller will roll in a single pass, see FIG. 2B). In other words, the wheelbase of the greens roller 10 is narrower that the roller width. This allows the greens roller 10 to navigate narrow pathways, which are typically used on golf courses, without compromising the width of the rollers.

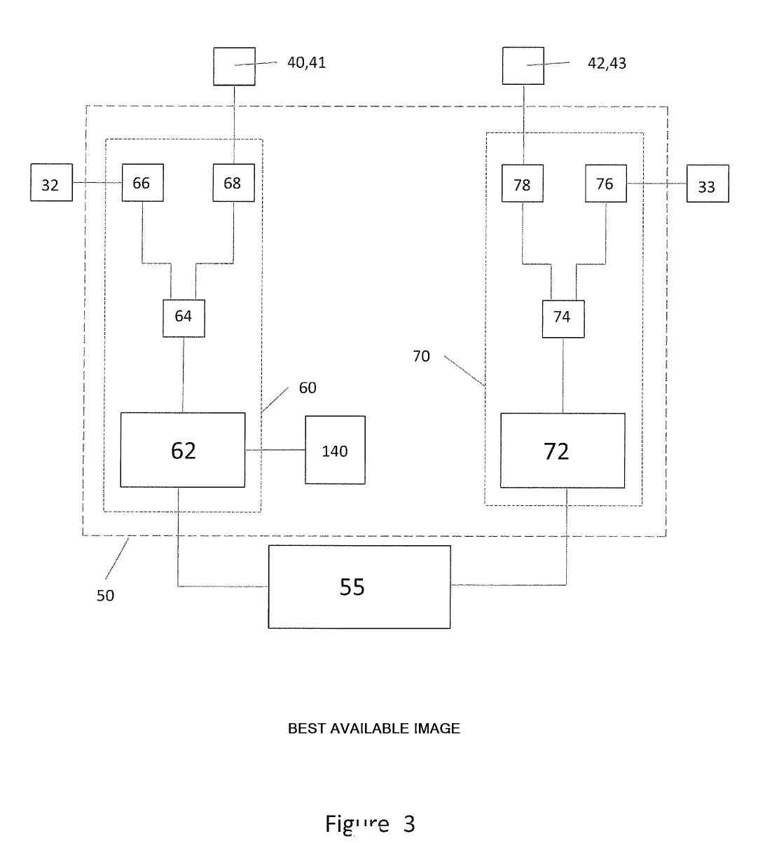

Referring to FIG. 3, the rear wheels 32, 33 and rollers 40, 41, 42, 43 are selectively driven by a hydraulic system 50, which is powered by a motor, shown as petrol motor 55. The hydraulic system has a first hydrostatic transmission 60 and a second hydrostatic transmission 70, which are both powered by the petrol motor 55.

The first hydrostatic transmission 60 has a power source, shown as first pump 62. The output from the first pump 62 passes through a first hydraulic switch 64 that selectively directs the hydraulic output of the first pump 62 to either a first hydraulic motor 66 or a second hydraulic motor 68. The first hydraulic motor 66 is connected to the rear left wheel 32. The second hydraulic motor 68 is connected to the left rollers 40, 41.

The second hydrostatic transmission 70 has a power source, shown as second pump 72. The output from the second pump 72 passes through a second hydraulic switch 74 that selectively directs the hydraulic output of the second pump 72 to either a third hydraulic motor 76 or a fourth hydraulic motor 78. The third hydraulic motor 76 is connected to the rear right wheel 32. The fourth hydraulic motor 78 is connected to the right rollers 42, 43.

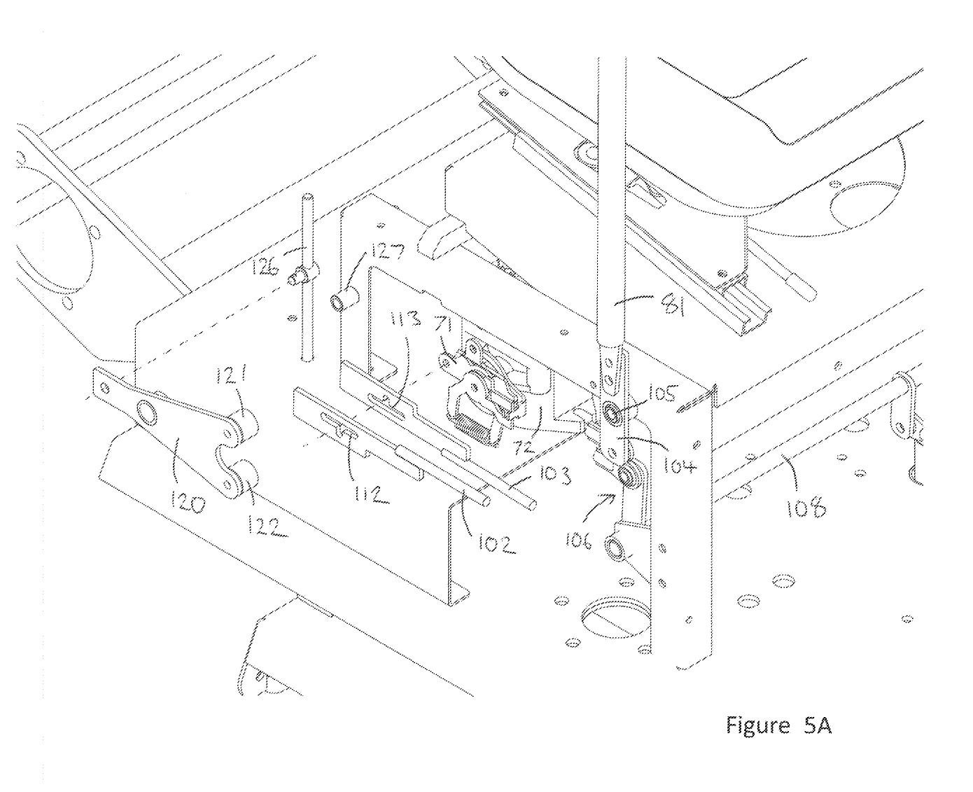

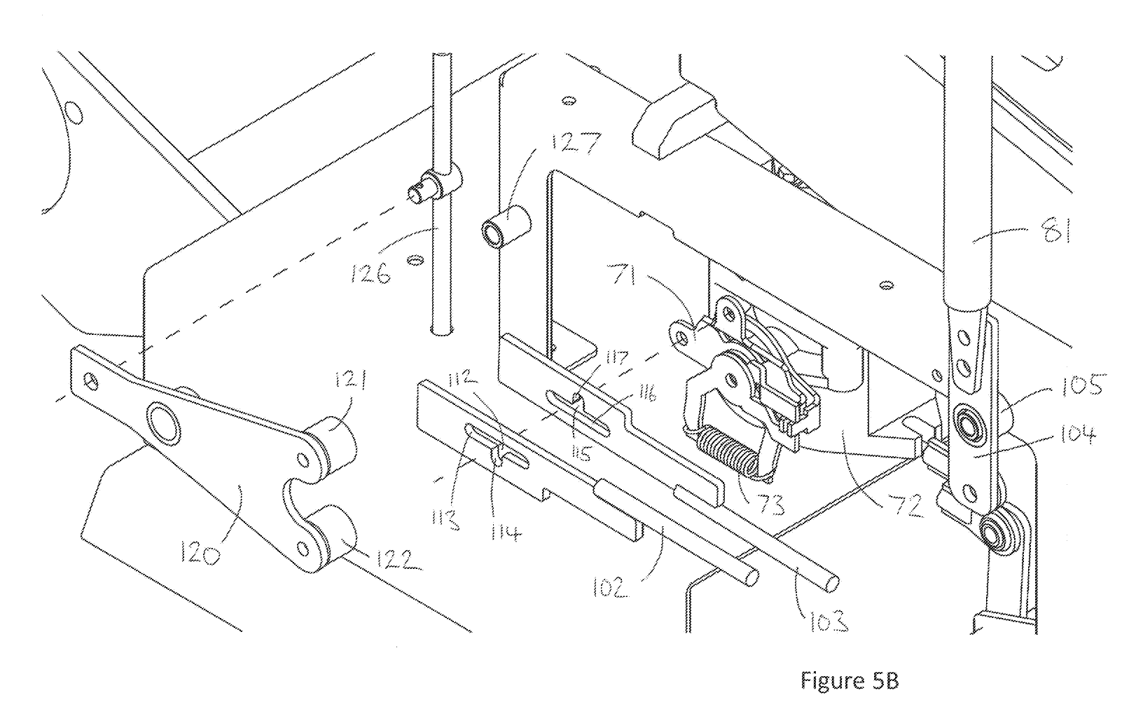

Referring to FIG. 5B and the second pump 72, the flow rate and the direction of flow in the second pump 72 is controlled by a flow actuator 71 on the exterior of the pump 72, shown in FIG. 5B in the neutral position. Rotation of the throttle plate 71 away from a neutral position results in fluid flow through the second pump 72. The direction of rotation relative to the neutral position determines the direction of flow, and the degree of rotation away from the neutral position determines the rate of flow. The flow actuator 71 is biased towards the neutral position by a spring 73. The first pump 62 has a corresponding flow actuator 61 and spring 63, which function in the same way as flow actuator 71 and spring 73.

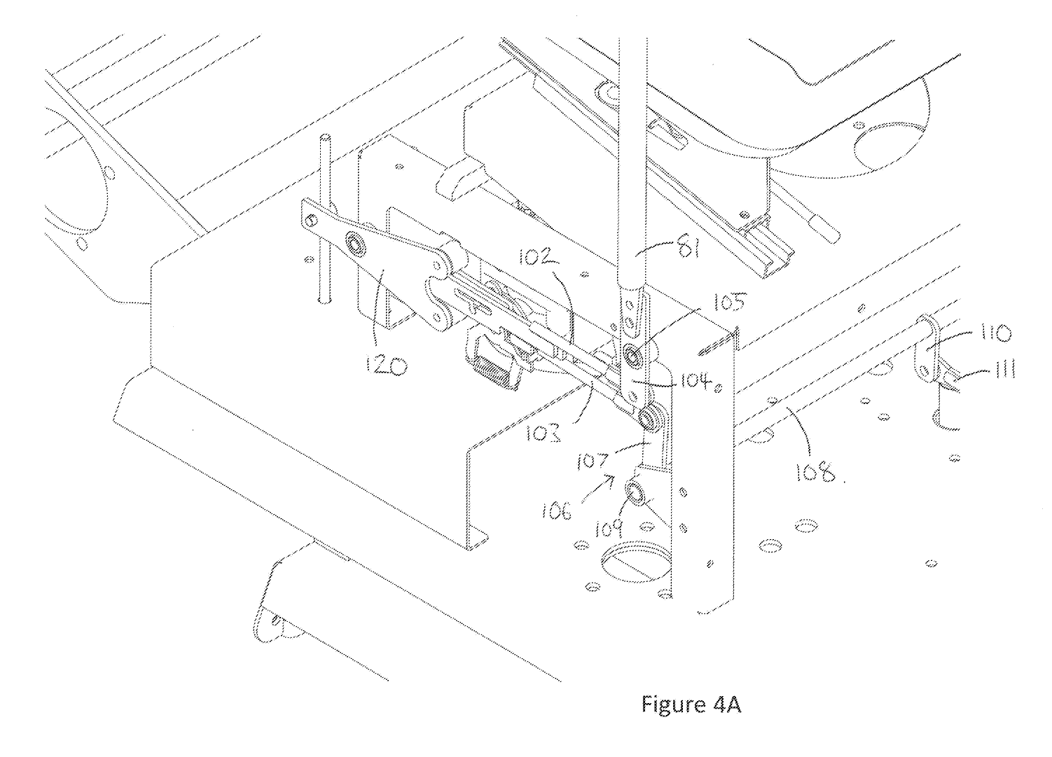

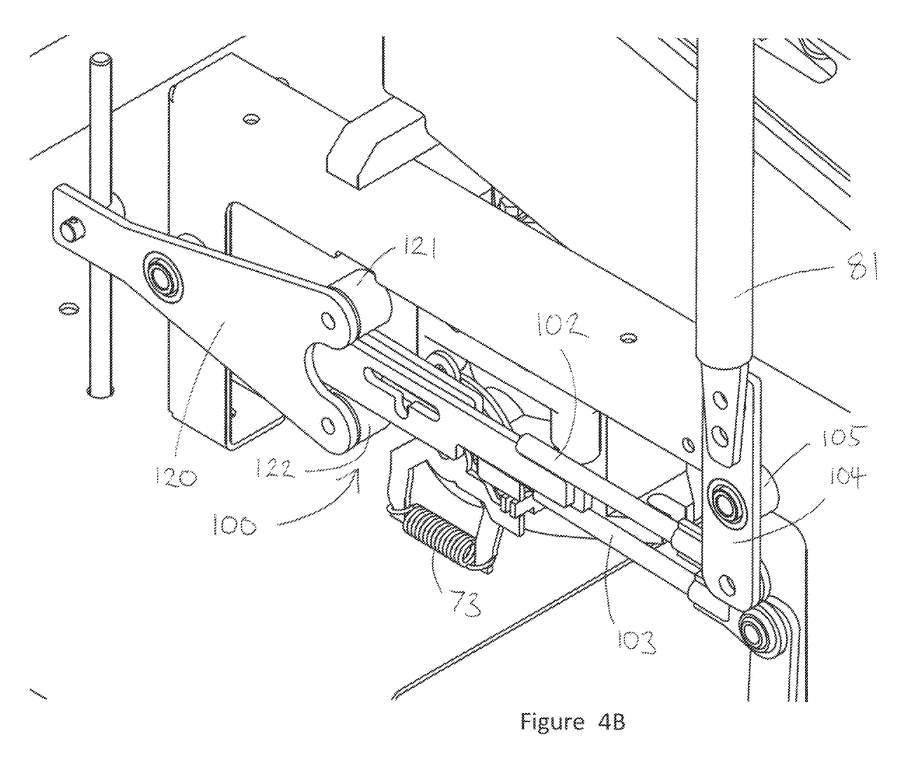

Referring to the second hydrostatic transmission 70 (shown in 2C, 2D and 4A to 5B), the second pump 72 has a coupling mechanism 100 that selectively connects the flow actuator 71 to either a first actuator, shown as right lever 81, or a second actuator, shown as pair of left and right pedals 90, 91. Referring to FIG. 4B, the coupling mechanism has a first push bar 102 and a second push bar 103. The first push bar 102 is connected to the right lever 81 by a connecting member 104 that is rotatably connected to the chassis 20 at a pivot 105. When a user pulls the right lever 81 towards them (towards the rear 14 of the greens roller 10) the connecting member 104 pivots about the pivot 105, thereby pulling the push bar 102 towards the front 12 of the greens roller 10. When a user pushes the right lever 81 away from them (towards the front 12 of the greens roller 10) the connecting member 104 pivots about the pivot 105, thereby pushing the push bar 102 towards the rear 14 of the greens roller 10.

The second push bar 103 is connected to the left and right pedals 90, 91 by a linkage, shown as articulated linkage 106. The articulated linkage 106 comprises a connecting member 107 fixed to a connecting rod 108. The connecting rod 108 is rotatably attached to the chassis at pivot point 109. The connecting rod 108 has a flange 110 fixed to the connecting rod 108. The flange 110 is rotatably connected to a pedal push bar 111.

When a user presses on the left pedal 90 the pedal push bar 111 is pulled forward (towards the front 12 of the greens roller 10) and causes the connecting rod 108, and thereby the connecting member 107, to rotate about pivot point 109. This action pushes the second push bar 103 towards the rear 14 of the greens roller 10. When a user presses on the right pedal 91 the pedal push bar 111 is pushed backwards (towards the rear 14 of the greens roller 10) and causes the connecting rod 108, and thereby the connecting member 107, to rotate about pivot point 109. This action pulls the second push bar 103 towards the front 12 of the greens roller 10.

The first push bar 102 and the second push bar 103 are positioned side-by-side and are held in position by a selector 120. The selector has first and second rollers, shown as upper and lower rollers 121, 122, that maintain, through contact, the position of the first and second push bars 102, 103. The rollers 121, 122 allow the first and second push bars 102, 103 to slide relative to the selector when being pushed or pulled by the right lever 81 or the pedals 90, 91, respectively.

The first push bar 102 has a “T” shaped aperture 112 comprising a slot section 113 and a notch section 114. The second push bar 102 has a “T” shaped aperture 115 comprising a slot section 116 and a notch section 117. The aperture 112 in the first push bar 102 resembles an upright “T” and the aperture 115 in the second push bar 103 resembles an upside down “T”. When the first and second push bars are positioned side-by-side the slot 113 of the first push bar 102 aligns with the notch 117 of the second push bar 103, and the slot 116 of the second push bar 103 aligns with the notch 114 of the first push bar 102.

A pin 101 attached to a hole 75 in the flow actuator 71 extends through the apertures 112, 115 in the first and second push bars 102, 103. The pin 101 can therefore either extend through the notch 117 in the second push bar 103 and the slot 113 in the first push bar 102 (rolling position), or the pin can extend through the slot 116 in the second push bar 103 and the notch 114 in the first push bar 102 (transportation position). In the rolling position lateral movement of the second push bar 103 results in rotation of the flow actuator 71, via the pin 101 and notch 117 connection. In the transportation position lateral movement of the first push bar 102 results in rotation of the flow actuator 71, via the pin 101 and notch 114 connection.

Referring to FIGS. 2C and 2D, the selector 120 is used to change the first and second push bars 102, 103 between the rolling position and the transportation position by varying the vertical position of the first and second push bars 102, 103. The selector is connected to the rear wheels 42, 43 by a selector linkage, shown as articulated selector linkage 125. The rollers 121, 122 are located at a first end 123 of the selector 120. A first connecting rod 126 is attached to a second end 124 of the selector 120. The selector 120 is rotatably attached to the chassis 20 at pivot 127, located between the first end 123 and the second end 124.

The first connecting rod 126 is attached to a rocker arm 128 that is rotatably attached to the chassis 20 at pivot 129. A second connecting rod 130 connects the rocker arm 128 to a rear chassis member 24, via a pin 131. The pin 131 extends through a slot 132 in the second connecting rod 130. The first and third hydraulic motors 66, 76 are mounted to the rear chassis member 24, with the rear wheels being mounted on the first and third hydraulic motors. The front wheels 30, 31 are pivotally mounted on a front chassis member 23.

When the user lowers the wheels 30, 31, 32, 33, by lowering the front and rear chassis members 23, 24, a first end 133 of the slot 132 contacts the pin 131 to pull the rocker arm 128 towards the rear 14 of the greens roller 10, thereby pulling the connecting rod 126 downwards and pivoting the selector 120 upwards so that the first and second push bars 102, 103 are in the transportation position. When the user raises the wheels a second end 134 of the slot 132 contacts the pin 131 to push the rocker arm 128 towards the front 12 of the greens roller 10, thereby pushing the connecting rod 126 upwards and pivoting the selector 120 downwards so that the first and second push bars 102, 103 are in the rolling position.

The slot 132 allows significant movement of the rear chassis member 24 to only cause movement of the rocker arm 128 at the extremities of the movement. As the selector is connected to the movement of the wheels the change of the push bars 102, 103 between the transportation position and the rolling position is automatic. In other words the coupling mechanism 100, which comprises the first and second push bars 102, 103, is automatically activated to selectively connect either the first actuator or the second actuator to the power source.

The first hydrostatic transmission 60 has a corresponding set of linkages that operate in the same way as those described above for the second hydrostatic transmission 70. However, instead of connecting to the right lever 81, the first hydrostatic transmission 60 is connected to a left lever 80. The connecting rod 108 for the pedals 90, 91 extends between first and second hydrostatic transmissions 60, 70 so that pushing one pedal rotates the flow actuators in the same direction at the same time, thereby driving both the left and right rollers 40, 41, 42, 43 in the same direction.

The selectors 120 of the first and second hydrostatic transmissions operate simultaneously so that when the greens roller is in the transportation configuration the user can use the left and right levers 80, 81 to control the greens roller 10, and when the greens roller 10 is in the rolling configuration the user can use the left and right pedals 90, 91 to control the greens roller 10. In the rolling configuration the left pedal 90 drives the rollers 40, 41, 42, 43 to move the greens roller 10 to the left, and the right pedal 91 drives the rollers 40, 41, 42, 43 to move the greens roller 10 to the right. In the transportation configuration the left lever 80 drives only the rear left wheel 32 (via the first hydraulic motor 66) and the right lever 81 drives only the rear right wheel 33 (via the third hydraulic motor 76).

To drive the greens roller 10 forward in the transportation configuration a user pushes both the left lever 80 and the right lever 81 forward the same amount, thereby driving the left rear wheel 32 and the right rear wheel 33 the same amount. To gradually turn left the user can reduce the drive to the rear left wheel 32 (the user can do the same to the rear right wheel 33 to gradually turn right). To reverse the user pulls both levers 80, 81 back the same amount. To perform a “zero turn” the user pulls one lever backwards and pushes one lever forwards. In the rolling configuration the user can use the steering wheel 25 to angle the rollers 40, 41, 42, 43, allowing the user to direct the path of the greens roller 10 when rolling.

The user can raise or lower the wheels 30, 31, 32, 33 by activating a button, such as an up/down switch, on the “dashboard” 26 of the greens roller. The button activates an auxiliary pump 140 that is attached to the first pump 62. The auxiliary pump 140 drives a ram 142 and articulated linkage 144 located under the chassis 22, with the articulated linkage 144 being attached to the front and rear chassis members 23, 24. The front and rear chassis members 23, 24 are rotatably attached to the chassis 20. Movement of the ram 142 therefore causes the chassis members, and thereby the wheels 30, 31, 32, 33, to rotate into a transportation position in which the wheels support the greens roller 10, or to rotate into a raised position in which the wheels do not contact the ground.

In use at a golf course, the user will take the greens roller 10 from its storage location (e.g. near the clubhouse) and will drive it (in the transportation configuration) to the first green that the user wishes to roll. The user drives the greens roller by using the left and right levers 80, 81 to drive the left and right rear wheels 32, 33, respectively. Referring to the right lever 81, when in the transportation position the pin 101 is located in the notch 114 of the first push bar 102 so that movement of the right lever 81 moves the flow actuator 71.

Once the user arrives at the desired green the user pushes the button to activate the auxiliary pump 140 to raise the wheels 30, 31, 32, 33, thereby changing the greens roller 10 from the transportation configuration to the rolling configuration. As the wheels move from the lowered position to the raised position the selector automatically moves the first and second push bars 102, 103 into the rolling position. A contact switch (not shown) on the chassis, which is contacted when the wheels are fully raised, activates the first and second hydraulic switches 64, 74 to direct the output of the first and second hydraulic pumps 62, 72 to the rollers 40, 41, 42, 43. The switches 64, 74 are therefore automatically switched when the wheels 30, 31, 32, 33 are raised.

The greens roller is now supported by the rollers 40, 41, 42, 43 and the pin 101 is now located in notch 117 of the second push bar 103 so that movement of the pedals 90, 91 moves the flow actuator 71. The user can then roll the green using the left pedal 90 to drive the rollers left or the right pedal 91 to drive the rollers right. The user can also use the steering wheel 25 to angle the rollers 40, 41, 42, 43 to allow them to progress forwards on the green while rolling the green side-to-side.

Once the green is completely rolled the user pushes the button to activate the auxiliary pump 140 to lower the wheels 30, 31, 32, 33 and change the greens roller 10 from the rolling configuration to the transportation configuration. As the wheels move from the raised position to the lowered position the selector automatically moves the first and second push bars 102, 103 into the transportation position. As the wheels are lowered the contact switch is disengaged and deactivates the first and second hydraulic switches 64, 74 so that the output of the first and second hydraulic pumps 62, 72 is directed to the rear wheels 32, 33. The switches 64, 74 are therefore automatically switched when the wheels 30, 31, 32, 33 are lowered. The user then drives to the next green and the process is repeated.

Referring to FIGS. 2C and 2D, the articulated selector linkage 125 also has a first spring 135 and a second spring 136 that maintain the position of the selector 120. The springs act as a protection mechanism so that if the wheels are raised or lowered when the flow actuator 71 is away from the neutral position the transition of the selector 120 will occur once the flow actuator 71 is in the neutral position and the pin 101 can move into the desired notch 114, 117.

While the power sources have been described above as hydraulic pumps, it will be understood that the hydraulic pumps and corresponding hydraulic motors could be replaced with batteries, controllers and electric motors. This would remove the need for a petrol motor and the hydraulic systems. Such a modification could be useful for greens rollers used at golf courses, as golf carts are often electric and the golf course will already have charging infrastructure.

It is envisaged that the greens roller could be a golf greens roller, a lawn bowls greens roller, a grass tennis court greens roller, or a golf fairway greens roller.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1-14. (canceled)

15. A greens roller having a transportation configuration and a rolling configuration, the greens roller comprising:
a chassis having powered wheels, the wheels defining a driving direction;
one or more rollers rotatably mounted to the chassis, the one or more rollers defining a rolling direction that is different from the driving direction;
wherein in the transportation configuration the wheels are lowered to support the chassis for driving the greens roller, and in the rolling configuration the wheels are raised so that the one or more rollers support the chassis for rolling the greens roller on a green.

16. The greens roller according to claim 1, wherein the driving direction is angled to the rolling direction.

17. The greens roller according to claim 2, wherein the driving direction is substantially perpendicular to the rolling direction.

18. The greens roller according to claim 1, wherein a driver's seat is mounted to the chassis, the driver's seat being substantially aligned with the driving direction.

19. The greens roller according to claim 1, wherein a width of the greens roller is narrower than a width of the one or more rollers.

20. The greens roller according to claim 1, further comprising:
a power source mounted to the chassis;
a first actuator for driving the wheels;
a second actuator for driving the rollers; and
a coupling mechanism configured to selectively connect either the first actuator or the second actuator to the power source.

21. The greens roller according to claim 6, wherein the coupling mechanism has a first push bar and a second push bar.

22. The greens roller according to claim 7, wherein the first push bar and the second push bar are positioned side-by-side and are held in position by a selector, the selector being configured to change the first and second push bars between a rolling position and a transportation position by varying the vertical position of the first and second push bars.

23. The greens roller according to claim 6, wherein the first actuator for driving the wheels is a lever.

24. The greens roller according to claim 6, wherein the second actuator for driving the rollers is a pedal.

25. A greens roller having a transportation configuration and a rolling configuration, the greens roller comprising:
a chassis having wheels;
one or more rollers rotatably mounted to the chassis;
a power source mounted to the chassis;
a first actuator for driving the wheels;
a second actuator for driving the rollers; and
a coupling mechanism configured to selectively connect either the first actuator or the second actuator to the power source;
wherein in the transportation configuration the wheels are lowered to support the chassis and the coupling mechanism connects the first actuator to the power source, and in a rolling configuration the wheels are raised so that the one or more rollers support the chassis and the coupling mechanism connects the second actuator to the power source.

26. The greens roller according to claim 11, wherein the coupling mechanism is automatically activated when the wheels transition between a raised position and a lowered position.

27. The greens roller according to claim 11, wherein a linkage connects the wheels and the coupling mechanism.

28. The greens roller according to claim 13, wherein the coupling mechanism has a first push bar and a second push bar that are positioned side-by-side and are held in position by a selector, wherein the selector is configured to change the first and second push bars between a rolling position and a transportation position by varying the vertical position of the first and second push bars.
